(19) United States
(12) Patent Application Publication
(10) Pub. No.: US 2021/0177011 A1
(43) Pub. Date: Jun. 17, 2021

(54) PET FOOD SUPPLEMENTAL COATING METHOD

(71) Applicant: Ricky Memije, Castle Rock, CO (US)

(72) Inventor: Ricky Memije, Castle Rock, CO (US)

(21) Appl. No.: 16/711,051

(22) Filed: Dec. 11, 2019

(51) Int. Cl. A23K 40/30; A23K 50/40; A23N 17/00

(52) U.S. Cl. CPC A23K 40/30; A23N 17/00; A23K 50/40

(57) ABSTRACT

A pet food supplemental coating method for coating pet foods with supplemental powders includes placing the supplemental powder in a container, placing the pet food product in a basket assembly and thereafter positioning the basket assembly into the container. A lid is positioned on the container to close the container and the container shaken to coat the pet food with the supplemental powder. The lid is removed from the container such that the basket assembly and pet food therein can be removed from the container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet food coating methods and more particularly pertains to a new pet food coating method for coating pet foods with supplemental powders. Many pets are fed insects or pellets but may need supplements to augment their dietary needs. These supplements may be in powder form and attaching the supplements to the pet's existing food items may increase the likelihood of ingestion.

### (2) Description of Related Art Including Information Disclosed Under 37 CFR 1.97 and 1.98

The prior art relates to devices used to lower food items into containers and then to allow removal without having to reach into and touch the food items while submerged. These items typically are used in brining or storing items in a liquid medium to prevent spoil. Some devices use a grid to allow breading to pass through to a food item on the other side of the grid within an enclosed container. The prior art is silent on devices or methods related adding supplemental powders to pet food items.

### BRIEF SUMMARY OF THE INVENTION

An embodiment of the disclosure meets the needs presented above by generally comprising a method of coating pet food product with supplemental powders. The supplemental powder in a container and pet food product is then placed into a basket assembly. The basket assembly is positioned into the container and a lid is placed on the container to close the container. The container is shaken to coat the pet food product with the supplemental powder. The lid is removed and the basket assembly is taken from the container. The now coated pet food product is thereafter removed from the basket assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a broken, top front in-use view of a pet food supplemental coating method according to an embodiment of the disclosure.

FIG. 2 is a front side view of an embodiment of the disclosure illustrating the exterior of the container when all pieces are assembled.

FIG. 3 is an exploded view of an embodiment of the disclosure to show the orientation of the assembly of each component.

FIG. 4 is a handle side view of an embodiment of the disclosure.

FIG. 5 is a section view of an embodiment of the disclosure showing the features of an embodiment of the disclosure if bisected using line 5-5 of FIG. 4.

### DETAILED DESCRIPTION OF THE INVENTION

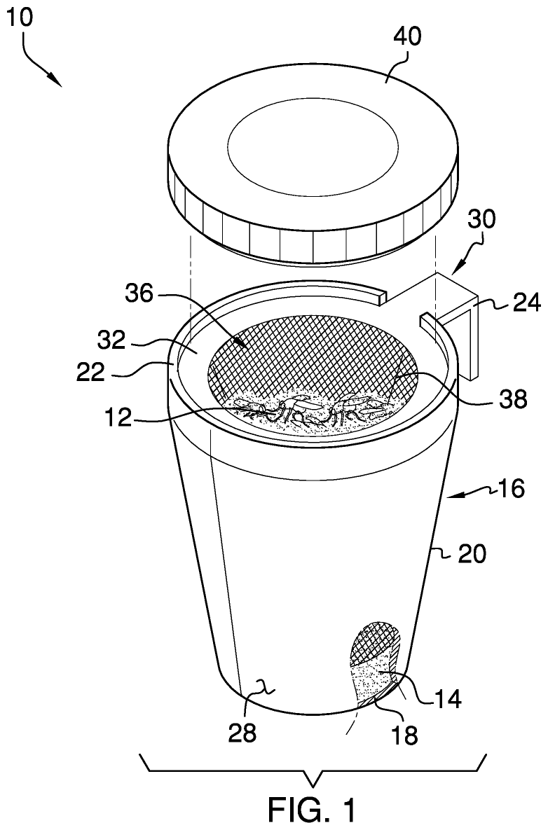

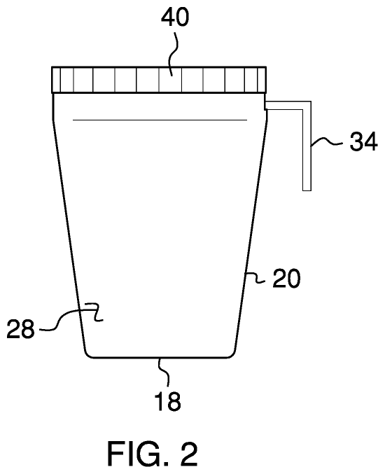

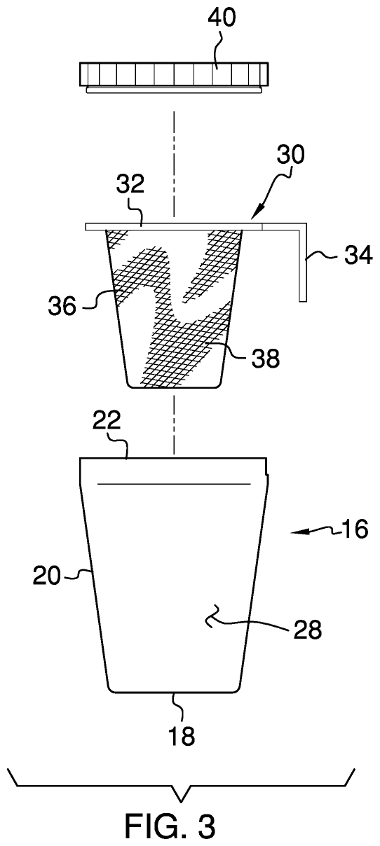

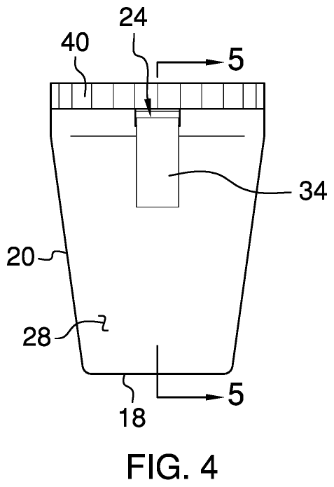

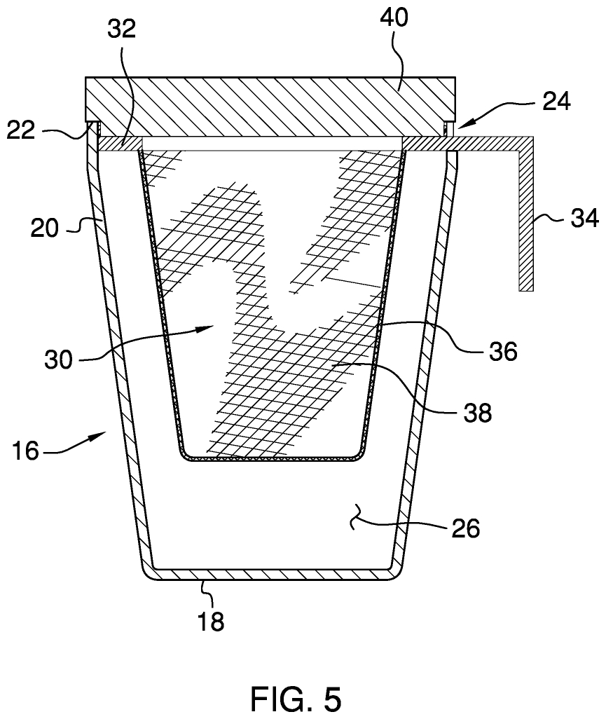

With reference now to the drawings, and in particular to FIGS. 1 through 5 thereof, a new pet food coating method embodying the principles and concepts of an embodiment of the disclosure and generally designated by the reference numeral 10 will be described.

As best illustrated in FIGS. 1 through 5, the pet food supplemental coating method 10 generally comprises a method of coating pet food product 12 with supplemental powders 14, said method includes numerous steps. First, place supplemental powder 14 in a container 16. The container 16 has a bottom wall 18. A perimeter wall 20 is attached to and extends upward from the bottom wall 18. The bottom wall 18 has a diameter between 2.00 and 3.50 inches. The perimeter wall 20 has a top edge 22 with respect to the bottom wall 18. The top edge 22 has a slot 24. The slot 24 extends therein and through an interior 26 and exterior 28 surfaces of the perimeter wall 20. The perimeter wall 20 increases in diameter between the bottom wall 18 and the top edge 22. The top edge 22 has diameter between 2.50 and 5.00 inches. The slot 24 has a depth between 0.25 and 0.50 inches. The slot 24 has a width between 0.25 and 0.75 inches along the top edge 22. The container 16 should not be filled to the top of the container 16 to allow the supplemental powder 14 room to move around the pet food product 12 in the container 16.

The next step is to place pet food product 12 in a basket assembly 30. The basket assembly 30 includes a rim 32 and a handle 34 is attached to and extends outwardly away from the rim 32. The handle 34 has a size to matingly engage the slot 24 in the container 16 such that the handle 34 extends outwardly from the container 16. A mesh receiver 36 is coextensive with and extends downwardly from the rim 32. The mesh receiver 36 has apertures 38 therein to allow the supplemental powder 14 to move through the mesh receiver 36 while inhibiting the pet food product 12 from moving through the mesh receiver 36. The basket assembly 30 should not be filled to capacity to best allow room for interaction between the pet food product 12 and supplemental powder 14.

Next, position the basket assembly 30 into the container 16. The basket assembly 30 is spaced from the bottom wall 18 when the handle 34 is engaged with the slot 24. The space between the basket assembly 30 and the container 16 varies be between 0.25 and 2.00 inches. The space allows for increased movement of the supplemental powders 14 and pet food product 12 to improve the coating of the pet food product 12.

A lid 40 is positioned on the container 16 to close the container 16. The lid 40 should engage all components to secure the components together and also form a tight seal to keep the supplemental powder 14 within the container 16.

The container 16 is thereafter shaken to coat the pet food product 12 with the supplemental powder 14. The container 16 should be sealed when all components are secured so shaking directions do not need to be restricted.

The lid 40 is removed and the basket assembly 30 is taken from the container 16 and such that the now coated pet food product 12 can be retrieved from the basket assembly 30. The pet food product 12 will be evenly coated with the supplemental powder 14. The basket assembly 30 may be shaken or tapped while partially removed from the container 16 to allow any loose supplemental powder 14 to return to the container 16 before completely removing the basket assembly 30. The pet food product 12 can be dumped out while holding the handle 34 on the basket assembly 30 so that it may be fed to a pet.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A method of coating pet food product with supplemental powders, said method including the steps of:
placing supplemental powder in a container;
placing pet food product in a basket assembly;
positioning said basket assembly into said container;
positioning a lid on said container to close said container;
shaking said container to coat said pet food product with said supplemental powder; and
removing said lid and said basket assembly from said container and removing said pet food product from said basket assembly.

2. The method of coating pet food product with supplemental powders of claim 1, wherein the step of placing supplemental powder in said container further comprises said container including:
a bottom wall;
a perimeter wall being attached to and extending upward from said bottom wall; and
a top edge with respect to said bottom wall.

3. The method of coating pet food product with supplemental powders of claim 2, wherein the step of placing supplemental powder in said container further comprises said top edge having a slot extending therein and through an interior and exterior surface of said perimeter wall.

4. The method of coating pet food product with supplemental powders of claim 2, wherein the step of placing supplemental powder in said container further comprises said bottom wall having a diameter between 2.00 and 3.50 inches.

5. The method of coating pet food product with supplemental powders of claim 2, wherein the step of placing supplemental powder in a container further comprises said perimeter wall increasing in diameter between said bottom wall and said top edge.

6. The method of coating pet food product with supplemental powders of claim 2, wherein the step of placing supplemental powder in a container further comprises said top edge having diameter between 2.50 and 5.00 inches.

7. The method of coating pet food product with supplemental powders of claim 3, wherein the step of placing supplemental powder in a container further comprises said slot having a depth between 0.25 and 0.50 inches.

8. The method of coating pet food product with supplemental powders of claim 3, wherein the step of placing supplemental powder in a container further comprises said slot having a width between 0.25 and 0.75 inches along said top edge.

9. The method of coating pet food product with supplemental powders of claim 1, wherein the step of placing pet food product in a basket assembly further comprises a basket assembly including:
a rim; and
a mesh receiver being coextensive with and extending downwardly from said rim.

10. The method of coating pet food product with supplemental powders of claim 3, wherein the step of placing pet food product in a basket assembly further comprises a basket assembly including:
a rim; and
a mesh receiver being coextensive with and extending downwardly from said rim.

11. The method of coating pet food product with supplemental powders of claim 9, wherein the step of placing pet food product in a basket assembly further comprises a rim having a handle being attached to and extending outwardly away from said rim.

12. The method of coating pet food product with supplemental powders of claim 10, wherein the step of placing pet food product in a basket assembly further comprises said handle having a size to matingly engage said slot in said container such that said handle extends outwardly from said container.

13. The method of coating pet food product with supplemental powders of claim 10, wherein the step of placing pet food product in a basket assembly further comprises said mesh receiver having apertures therein to allow said supplemental powder to move through said mesh receiver while inhibiting said pet food product from moving through said mesh receiver.

14. The method of coating pet food product with supplemental powders of claim 12, wherein the step of positioning said basket assembly in said container further comprises said basket assembly being spaced from said bottom wall when said handle is engaging with said slot.

15. A method of coating pet food product with supplemental powders, said method including the steps of:
placing supplemental powder in a container, said container having a bottom wall and a perimeter wall being attached to and extending upward from said bottom wall, said bottom wall having a diameter between 2.00 and 3.50 inches, said perimeter wall having a top edge with respect to said bottom wall, said top edge having a slot extending therein and through an interior and exterior surface of said perimeter wall, said perimeter wall increasing in diameter between said bottom wall and said top edge, said top edge having diameter between 2.50 and 5.00 inches, said slot having a depth between 0.25 and 0.50 inches, said slot having a width between 0.25 and 0.75 inches along said top edge;
placing pet food product in a basket assembly, said basket assembly including a rim and a handle being attached to and extending outwardly away from said rim, said handle having a size to matingly engage said slot in said container such that said handle extends outwardly from said container, a mesh receiver being coextensive with and extending downwardly from said rim, said mesh receiver having apertures therein to allow said supplemental powder to move through said mesh receiver while inhibiting said pet food product from moving through said mesh receiver;
positioning said basket assembly into said container, wherein said basket assembly is spaced from said bottom wall when said handle is engaged with said slot;
positioning a lid on said container to close said container;
shaking said container to coat said pet food product with said supplemental powder; and
removing said lid and said basket assembly from said container and removing said pet food product from said basket assembly.

16. The method of coating pet food product with supplemental powders of claim 9, wherein the step of placing pet food product in a basket assembly further comprises said mesh receiver having apertures therein to allow said supplemental powder to move through said mesh receiver while inhibiting said pet food product from moving through said mesh receiver
